(19) United States
(12) Patent Application Publication
(10) Pub. No.: US 2022/0222319 A1
(43) Pub. Date: Jul. 14, 2022

(54) COMPRESSED MATRIX WITH SPARSITY METADATA

(71) Applicant: Microsoft Technology Licensing, LLC, Redmond, WA (US)

(72) Inventors: Derek Edward Davout GLADDING, Poughquag, NY (US); Nitin Naresh GAREGRAT, San Jose, CA (US)

(73) Assignee: Microsoft Technology Licensing, LLC, Redmond, WA (US)

(21) Appl. No.: 17/149,643

(22) Filed: Jan. 14, 2021

(51) Int. Cl. G06F 17/16

(52) U.S. Cl. CPC G06F 17/16

(57) ABSTRACT

A computing device is provided, including one or more processing devices configured to receive a first matrix including a plurality of first matrix elements arranged in a plurality of submatrices. The one or more processing devices may be further configured to generate first matrix sparsity metadata indicating one or more zero submatrices and one or more nonzero submatrices of the plurality of submatrices. Each of the first matrix elements included in the one or more zero submatrices may be equal to zero. The one or more processing devices may be further configured to store, in memory, a compressed first matrix including the first matrix sparsity metadata and the one or more nonzero submatrices and not including the one or more zero submatrices.

### BACKGROUND

When training machine learning models, computations are frequently performed on large matrices (e.g. with tens of thousands or hundreds of thousands of rows and columns). For example, matrix multiplication operations on such matrices are frequently performed. These large matrices may occupy large amounts of memory when stored. In addition, computations performed on large matrices are often very computationally resource-intensive in terms of both memory and processor utilization.

### SUMMARY

According to one aspect of the present disclosure, a computing device is provided, including one or more processing devices configured to receive a first matrix including a plurality of first matrix elements arranged in a plurality of submatrices. The one or more processing devices may be further configured to generate first matrix sparsity metadata indicating one or more zero submatrices and one or more nonzero submatrices of the plurality of submatrices. Each of the first matrix elements included in the one or more zero submatrices may be equal to zero. The one or more processing devices may be further configured to store, in memory, a compressed first matrix including the first matrix sparsity metadata and the one or more nonzero submatrices and not including the one or more zero submatrices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically depicts a computing device including a processor, a hardware accelerator, and memory, according to one example embodiment.

FIG. 2 shows an example first matrix including a plurality of submatrices, according to the example of FIG. 1.

FIG. 3 schematically shows the computing device when a matrix multiplication operation is performed at the hardware accelerator, according to the example of FIG. 1.

FIG. 4 shows an example first matrix that is multiplied by an example second matrix to obtain a result matrix, according to the example of FIG. 1.

FIG. 5 schematically shows the computing device when a compressed result matrix is computed, according to the example of FIG. 1.

FIG. 6A shows a flowchart of an example method for use with a computing device, according to the example of FIG. 1.

FIG. 6B shows additional steps of the method of FIG. 6A that may be performed to multiply a first matrix and a second matrix.

FIG. 6C shows additional steps of the method of FIG. 6A that may be performed subsequently to the steps of FIG. 6B to compute a compressed result matrix.

FIG. 6D shows additional steps of the method of FIG. 6A that may be performed in some examples.

FIG. 7 shows a schematic view of an example computing environment in which the computing device of FIG. 1 may be enacted.

### DETAILED DESCRIPTION

Matrices that are processed in machine learning settings are frequently sparse matrices in which large proportions of the matrix elements are equal to zero. In order to reduce the amount of memory required to store such matrices, the systems and methods for compressing sparse matrices described herein are provided, as discussed in further detail below. In addition, when sparse matrices are compressed according to such systems and methods, shortcuts may be performed when performing computations using the compressed matrices. These shortcuts may allow the processor and memory utilization for such computations to be reduced.

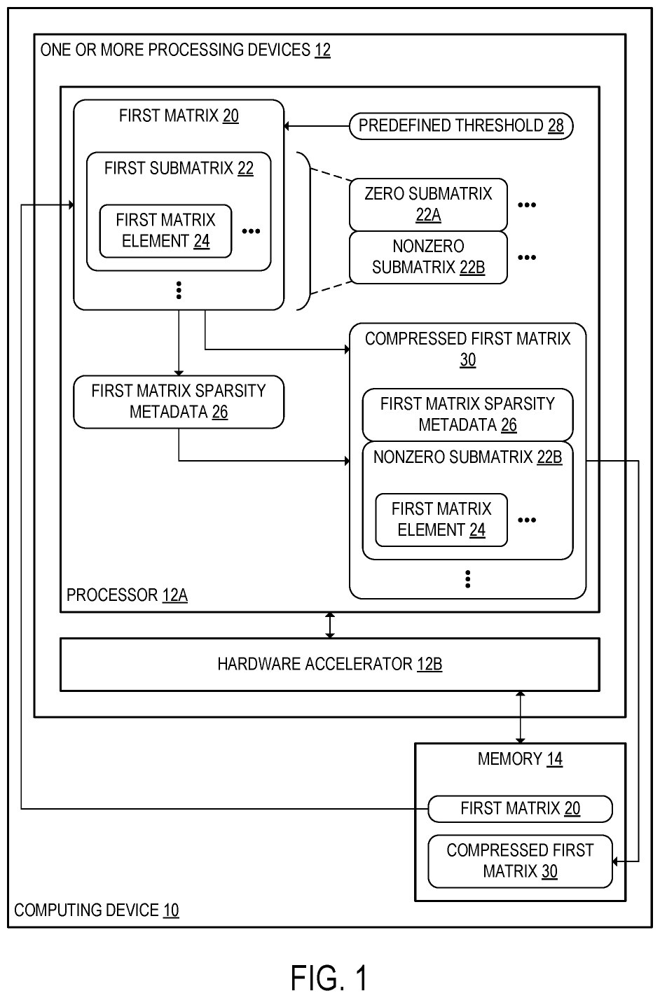

FIG. 1 schematically depicts a computing device 10, according to one example embodiment. The computing device 10 may include one or more processing devices 12 and memory 14. The one or more processing devices 12 may include a processor 12A, which may be a general-purpose processor. In some examples, as shown in FIG. 1, the one or more processing devices 12 may further include a hardware accelerator 12B that is specialized for performing a subset of computing tasks. The hardware accelerator 12B may be configured to perform the subset of computing tasks more efficiently than the processor 12A, and the processor 12A may be configured to offload such computing tasks to the hardware accelerator 12B. As discussed in further detail below, the hardware accelerator 12B may be specialized for performing matrix multiplication. The memory 14 included in the computing device 10 may include volatile memory and/or non-volatile memory. The memory 14 and the one or more processing devices 12 may be communicatively coupled such that the one or more processing devices 12 may store data in the memory 14 and retrieve data from the memory 14.

In some examples, the functionality of the computing device 10 may be distributed between a plurality of networked physical computing devices rather than being provided in a single physical computing device. For example, the computing device 10 may be instantiated in a data center, and one or more components of the computing device 10 may be provided in a plurality of physical computing devices that are located in the data center and connected via a network. The physical computing devices located in the data center may be configured to communicate with one or more client computing devices which may be located outside the data center and which may also at least partially instantiate one or more of the components of the computing device 10.

The one or more processing devices 12 may be configured to receive a first matrix 20 including a plurality of first matrix elements 24. Each first matrix element 24 included in the first matrix 20 may be a numerical value. In addition, the first matrix elements 24 may be arranged in a plurality of first submatrices 22. The plurality of first submatrices 22 may each be of a same size, such as 16×16 or 16×32. The size shared by each of the plurality of first submatrices 22 may be set at the one or more processing devices 12, for example, in response to receiving a user input. The number of rows included in the first matrix 20 may be a multiple of the number of rows included in each of the plurality of first submatrices 22, and the number of columns included in the first matrix 20 may be a multiple of the number of columns included in each of the plurality of first submatrices 22.

The one or more processing devices 12 may be further configured to generate first matrix sparsity metadata 26 indicating one or more zero submatrices 22A and one or more nonzero submatrices 22B of the plurality of first submatrices 22. Each of the first matrix elements 24 included in the one or more zero submatrices 22A are equal to zero. In addition, each of the one or more nonzero submatrices 22B includes at least one first matrix element 24 that is not equal to zero. Each first submatrix 22 may, in some examples, have a corresponding bit in the first matrix sparsity metadata 26 that indicates whether that submatrix is a zero submatrix 22A or a nonzero submatrix 22B. In such examples, the first matrix sparsity metadata 26 may indicate each of the one or more zero submatrices 22A with a zero and each of the one or more nonzero submatrices 22B with a one. Alternatively, the first matrix sparsity metadata 26 may indicate each of the one or more nonzero submatrices 22B with a zero and each of the one or more zero submatrices 22A with a one.

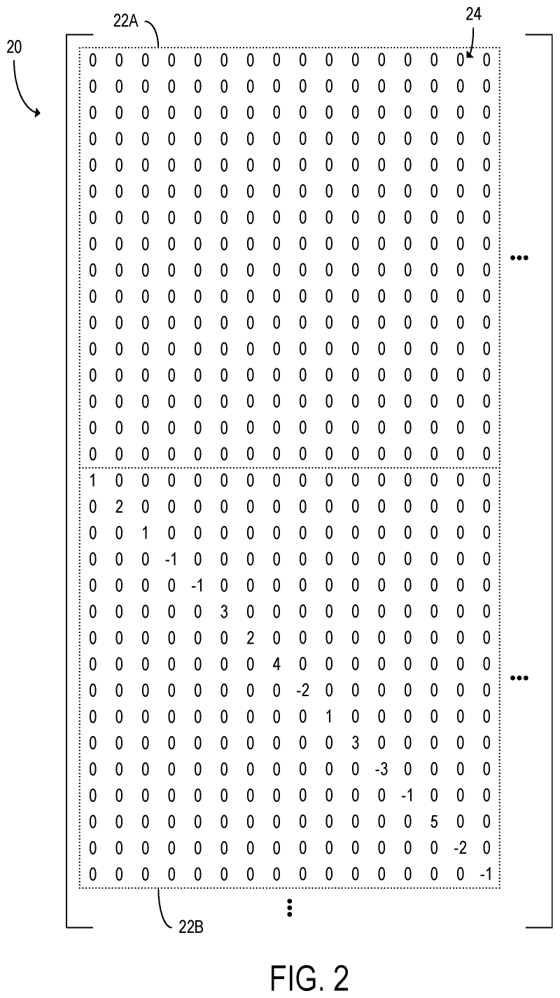

FIG. 2 shows an example of a first matrix 20 that includes a zero submatrix 22A and a nonzero submatrix 22B, each of which include a plurality of first matrix elements 24. In the example of FIG. 2, the first submatrices 22 are both 16×16. Although some of the first matrix elements 24 included in the nonzero submatrix 22B are equal to zero, the nonzero submatrix 22B includes first matrix elements 24 that are not equal to zero (in this example, along the diagonal of the nonzero submatrix 22B).

Returning to FIG. 1, the one or more processing devices 12 may be further configured to store, in the memory, a compressed first matrix 30 including the first matrix sparsity metadata 26 and the one or more nonzero submatrices 22B. The compressed first matrix 30 may be stored in a form not including the one or more zero submatrices 22A. Thus, the amount of memory used to store the compressed first matrix 30 may be reduced relative to the first matrix 20 since the one or more zero submatrices 22A are indicated by smaller amounts of data (in some examples, a single bit for each) in the first matrix sparsity metadata 26 compared to the uncompressed first matrix 20.

In some examples, prior to generating the first matrix sparsity metadata 26, the one or more processing devices 12 may be further configured to determine that one or more first matrix elements 24 of the plurality of first matrix elements 24 are below a predefined threshold 28. In response to making this determination, the one or more processing devices 12 may be further configured to set the one or more first matrix elements 24 that are below the predefined threshold 28 to zero. For example, the predefined threshold 28 may be equal to zero. Thus, in such examples, the one or more processing devices 12 may be configured to apply a rectified linear unit (ReLU) function to the first matrix elements 24. In other examples, the predefined threshold 28 may be a positive number.

Although, in the example of FIG. 1, the compressed first matrix 30 is generated at the processor 12A, the compressed first matrix 30 may alternatively be generated at the hardware accelerator 12B. In examples in which the compressed first matrix 30 is generated at the hardware accelerator 12B, the hardware accelerator 12B may be further configured to perform additional processing on the compressed first matrix 30 before outputting the compressed first matrix 30 to the processor 12A or the memory 14.

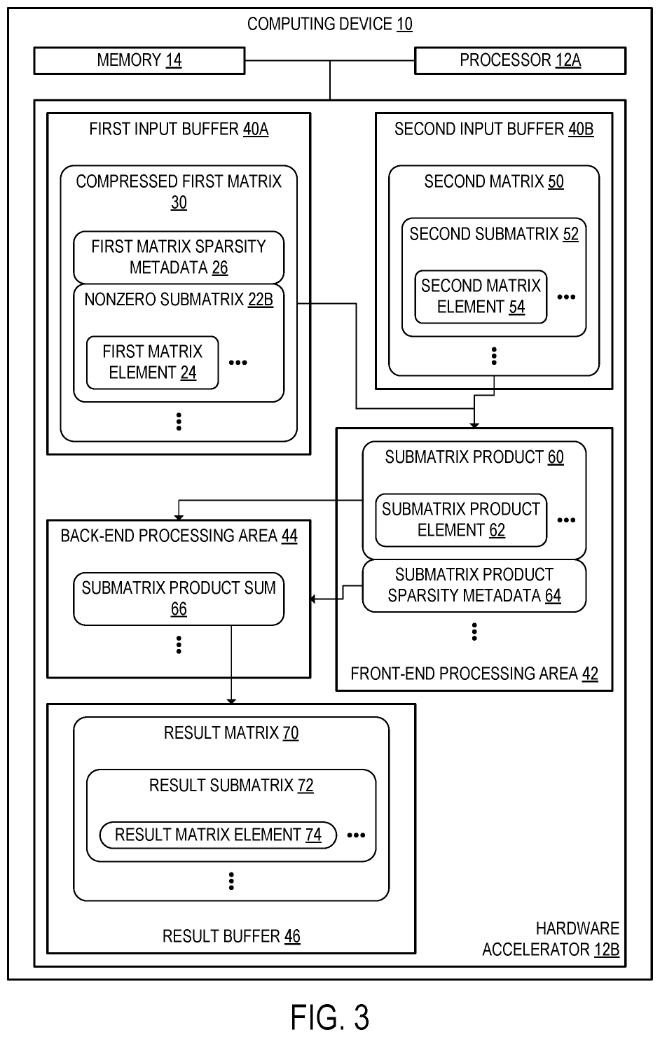

In some examples, as shown in FIG. 3, the hardware accelerator 12B may be configured to take the compressed first matrix 30 as an input. The compressed first matrix 30 may be received at the hardware accelerator 12B from the processor 12A or the memory 14. In the example of FIG. 3, the hardware accelerator 12B is configured to multiply the first matrix 20 (expressed as the compressed first matrix 30) and a second matrix 50 to compute a result matrix 70. The second matrix 50 may be arranged in a plurality of second submatrices 52, which may each include a plurality of second matrix elements 54. In addition, the result matrix 70 may be arranged in a plurality of result submatrices 72, which may each include a plurality of result matrix elements 74. The hardware accelerator 12B may be configured to receive the compressed first matrix 30 at a first input buffer 40A and receive the second matrix 50 at a second input buffer 40B. In addition, the hardware accelerator 12B may be further configured to output the result matrix 70 to a result buffer 46.

The hardware accelerator 12B may be configured to compute the result matrix 70 at least in part by computing a plurality of submatrix products 60 of the plurality of first submatrices 22 of the first matrix 20 and the plurality of second submatrices 52 of the second matrix 50, respectively. The plurality of submatrix products 60 may be computed at a front-end processing area 42 of the hardware accelerator 12B. As discussed in further detail below, the plurality of submatrix products 60 may be summed to compute the result submatrices 72. Computing the plurality of submatrix products 60 may include, for each submatrix product 60 of a zero submatrix 22A of the one or more zero submatrices 22A and a second submatrix 52 of the plurality of second submatrices 52, setting each submatrix product element 62 of the submatrix product 60 to zero. Each submatrix product element 62 of the submatrix product of a zero submatrix 22A and a second submatrix 52 may be set to zero without retrieving, from the memory 14, the plurality of first matrix elements 24 included in the zero submatrix 22A or the plurality of second matrix elements 54 included in the second submatrix 52. Thus, the number of memory calls made by the hardware accelerator 12B when multiplying the first matrix 20 and the second matrix 50 may be reduced. In addition, the hardware accelerator 12B may save processing time and bandwidth that would otherwise have been spent computing dot products between the first matrix elements 24 of the zero submatrix 22A and the second matrix elements 54 of the second submatrix 52.

In examples in which the hardware accelerator 12B is configured to compute a plurality of submatrix products 60, the hardware accelerator 12B may be further configured to assign submatrix product sparsity metadata 64 to each submatrix product 60 of the plurality of submatrix products 60. The submatrix product sparsity metadata 64 may indicate whether the submatrix product 60 is a zero submatrix product for which all the submatrix product elements 62 of the submatrix product 60 are equal to zero. For example, the hardware accelerator 12B may be configured to assign a zero to the submatrix product 60 as the submatrix product sparsity metadata 64 when the submatrix product 60 is a zero submatrix product and assign a one to the submatrix product 60 as the submatrix product sparsity metadata 64 when the submatrix product 60 is a nonzero submatrix product.

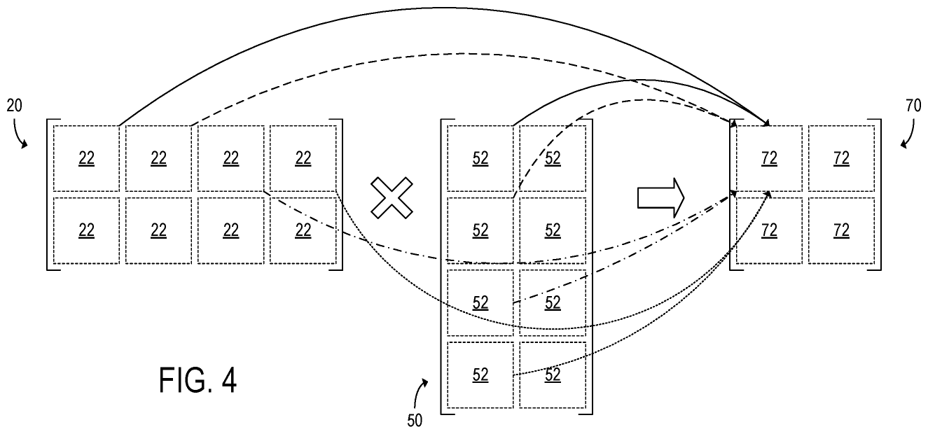

Multiplying the first matrix 20 and the second matrix 50 may further include computing a submatrix product sum 66 of two or more submatrix products 60 of the plurality of submatrix products 60 that share respective locations in the result matrix 70. The location of a submatrix product 60 in the result matrix 70 may be determined by the respective locations, in the first matrix 20 and the second matrix 50, of the first submatrix 22 and the second submatrix 52 for which the submatrix product 60 is computed. FIG. 4 shows an example first matrix 20 that is multiplied by an example second matrix 50 to obtain a result matrix 70. The example of FIG. 4 indicates four submatrix pairs, each including a first submatrix 22 and a second submatrix 52, that correspond to the same location in the result matrix 70. The submatrix products 60 of each of the four submatrix pairs may be summed to compute a result submatrix 72. The hardware accelerator 12B may be configured to compute a respective submatrix product sum 66 for each result submatrix 72 of the result matrix 70. In some examples, as shown in FIG. 3, the submatrix product sum 66 may be computed at a back-end processing area 44 of the hardware accelerator 12B.

When computing the submatrix product sum 66, the hardware accelerator 12B may be configured to determine, for each submatrix product 60 of the two or more submatrix products 60, whether that submatrix product 60 is a zero submatrix product in which all the submatrix product elements 62 are equal to zero. This determination may be made based on the submatrix product sparsity metadata 64 associated with each submatrix product 60. The hardware accelerator 12B may be further configured to skip adding each zero submatrix product to the submatrix product sum 66. Thus, unnecessary computations that would not change the submatrix product sum 66 may be avoided.

Although, in the example of FIG. 3, the first matrix 20 is expressed as the compressed first matrix 30 while the second matrix 50 is uncompressed, the second matrix 50 may also be compressed in some examples. In such examples, the submatrix product elements 62 of the submatrix products 60 may be set to zero when either the first submatrix 22 or the second submatrix 52 is indicated in its respective matrix sparsity metadata as being a zero submatrix. In other examples, although FIG. 3 shows the compressed first matrix 30 first in the ordering of the product of two matrices, and the uncompressed second matrix 50 as second in the ordering, the one or more processing devices 12 may additionally or alternatively be configured to multiply an uncompressed matrix by a compressed matrix.

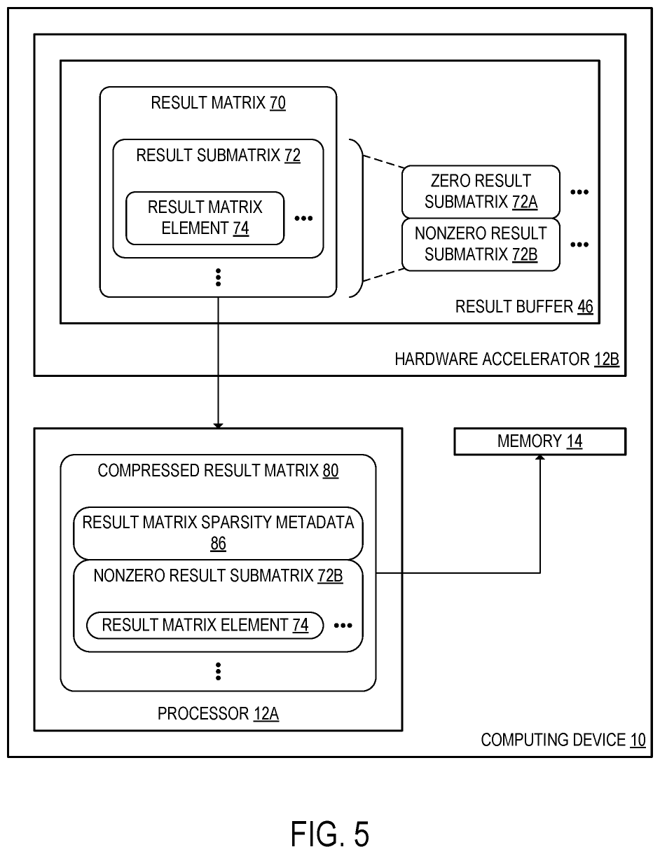

Subsequently to computing the result matrix 70, the one or more processing devices 12 may be further configured to generate a compressed result matrix 80, as shown in the example of FIG. 5. In the example of FIG. 5, the processor 12A is configured to generate the compressed result matrix 80 after receiving the result matrix 70 from the hardware accelerator 12B. However, in other examples, the compressed result matrix 80 may be generated at the hardware accelerator 12B. The compressed result matrix 80 may include result matrix sparsity metadata 86 indicating one or more zero result submatrices 72A and one or more nonzero result submatrices 72B of the result matrix 70. A zero result submatrix 72A is a result submatrix 72 in which all result matrix elements 74 are equal to zero, and a nonzero result submatrix 72B is a result submatrix 72 in which one or more result matrix elements 74 are not equal to zero. The compressed result matrix 80 may further include the one or more nonzero result submatrices 72B, without including the one or more zero result submatrices 72A. The one or more processing devices 12 may be further configured to store the compressed result matrix 80 in the memory 14.

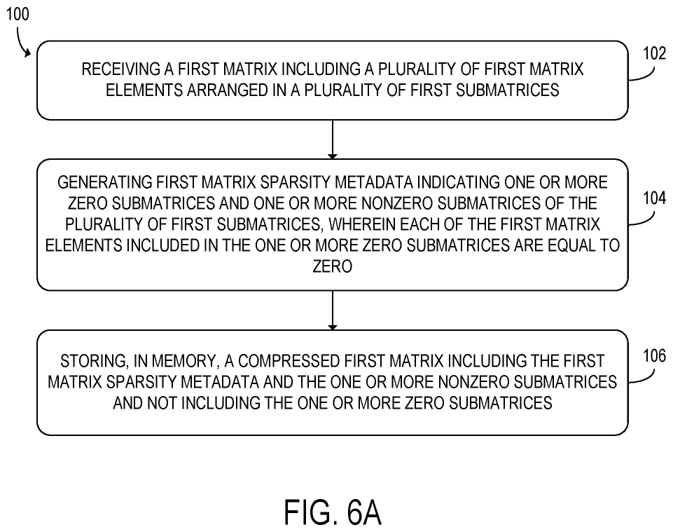

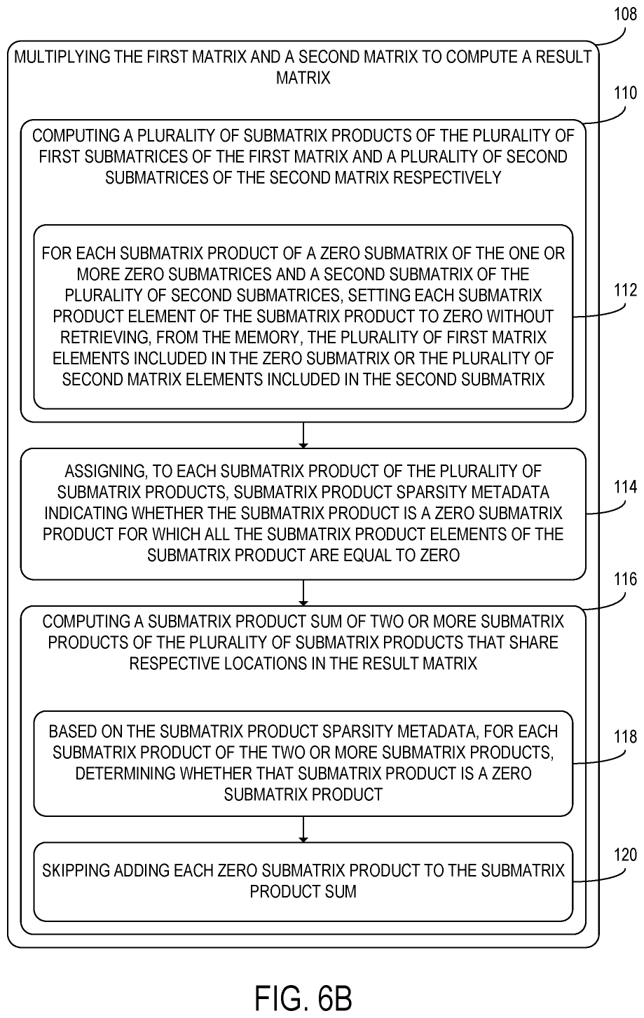

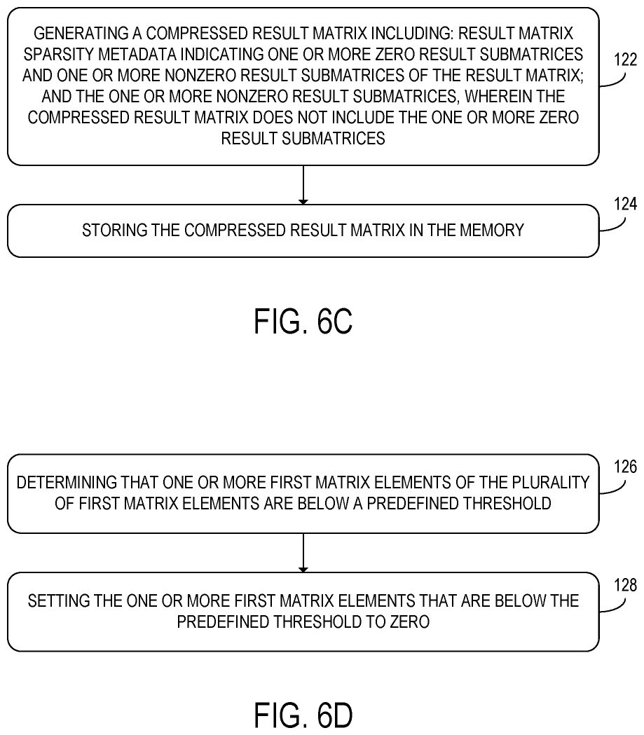

FIG. 6A shows a flowchart of an example method 100 for use with a computing device. The computing device at which the method 100 is performed may be the computing device 10 of FIG. 1 or some other computing device. The steps of the method 100 may be performed at one or more processing devices of the computing device, which may include a general-purpose processor and a hardware accelerator.

At step 102, the method 100 may include receiving a first matrix including a plurality of first matrix elements arranged in a plurality of first submatrices. The first matrix may be received from memory at a processing device of the one or more processing devices. The plurality of first submatrices may each be of a same size, such as 16×16 or 16×32.

At step 104, the method 100 may further include generating first matrix sparsity metadata for the first matrix. The first matrix sparsity metadata may indicate one or more zero submatrices and one or more nonzero submatrices of the plurality of first submatrices, where each of the first matrix elements included in the one or more zero submatrices are equal to zero. Each of the one or more nonzero submatrices includes at least one respective first matrix element that is not equal to zero. In some examples, the first matrix sparsity metadata may be stored as a header of the compressed first matrix. The first matrix sparsity metadata may use a respective bit associated with each of the first submatrices to indicate whether that submatrix is a zero submatrix. For example, the first matrix sparsity metadata may indicate each of the one or more zero submatrices with a zero and each of the one or more nonzero submatrices with a one.

At step 106, the method 100 may further include storing, in memory, a compressed first matrix including the first matrix sparsity metadata and the one or more nonzero submatrices. The compressed first matrix does not include the one or more zero submatrices. Thus, storage space that would otherwise be used to store the one or more zero submatrices may be saved.

FIGS. 6B-6D show additional steps of the method 100 that may be performed in some examples. As shown in FIG. 6B, the method 100 may further include, at step 108, multiplying the first matrix and a second matrix to compute a result matrix. Step 108 may be performed at a hardware accelerator included in the computing device at which the method 100 is performed. The first matrix may be expressed in the form of the first compressed matrix during step 108. When step 108 is performed at the hardware accelerator, the hardware accelerator may receive the compressed first matrix at a first input buffer and receive the second matrix at a second input buffer. Multiplying the first matrix and the second matrix may include, at step 110, computing a plurality of submatrix products of the plurality of first submatrices of the first matrix and a plurality of second submatrices of the second matrix respectively. The plurality of submatrix products may each include a plurality of submatrix product elements.

At step 112, computing the plurality of submatrix products may include, for each submatrix product of a zero submatrix of the one or more zero submatrices and a second submatrix of the plurality of second submatrices, setting each submatrix product element of the submatrix product to zero. The submatrix product elements may be set to zero without retrieving, from the memory, the plurality of first matrix elements included in the zero submatrix or the plurality of second matrix elements included in the second submatrix. Instead, the one or more processing devices at which the method 100 is performed may refer to the first matrix sparsity metadata and shortcut the computation of the submatrix product elements when the first submatrix is a zero submatrix. When the first submatrix is a nonzero submatrix, the submatrix product may instead be computed by computing a plurality of dot products between rows and columns of the nonzero submatrix and the second submatrix.

In some examples, at step 114, step 108 may further include assigning submatrix product sparsity metadata to each submatrix product of the plurality of submatrix products computed at step 110. The submatrix product sparsity metadata may indicate whether the submatrix product is a zero submatrix product for which all the submatrix product elements of the submatrix product are equal to zero. In some examples, the submatrix product sparsity metadata may be a single bit provided as a header of the submatrix product.

In examples in which the submatrix products are assigned submatrix product sparsity metadata, step 108 may further include, at step 116, computing a submatrix product sum of two or more submatrix products of the plurality of submatrix products that share respective locations in the result matrix. At step 118, computing the submatrix product sum may include, for each submatrix product of the two or more submatrix products, determining whether that submatrix product is a zero submatrix product. Whether the submatrix product is a zero submatrix product may be determined based on the submatrix product sparsity metadata for that submatrix product. In addition, at step 120, step 116 may further include skipping adding each zero submatrix product to the submatrix product sum. Thus, addition operations that would not affect the values of the result matrix elements may be skipped. In examples in which the result matrix is computed at the hardware accelerator, the result matrix may be output to a result buffer of the hardware accelerator after each result submatrix of the result submatrix has been computed.

FIG. 6C shows additional steps of the method 100 that may be performed subsequently to generating the result matrix as shown in FIG. 6B. At step 122, the method 100 may further include generating a compressed result matrix. The compressed result matrix may include result matrix sparsity metadata indicating one or more zero result submatrices and one or more nonzero result submatrices of the result matrix. Each result matrix element of a zero result submatrix is equal to zero, whereas each nonzero result submatrix includes at least one result matrix element that is not equal to zero. The compressed result matrix may further include the one or more nonzero result submatrices without including the one or more zero result submatrices. At step 124, the method 100 may further include storing the compressed result matrix in the memory.

FIG. 6D shows additional steps of the method 100 that may be performed prior to generating the first matrix sparsity metadata at step 104. At step 126, the method 100 may further include determining that one or more first matrix elements of the plurality of first matrix elements are below a predefined threshold. For example, the first predefined threshold may be zero. At step 128, the method 100 may further include setting the one or more first matrix elements that are below the predefined threshold to zero. Thus, for example, the first matrix elements may be rounded, or a ReLU function may be applied to the first matrix elements.

Using the devices and methods discussed above, the amount of memory used to store sparse matrices may be reduced. In addition, matrix multiplication operations performed on the compressed matrices may be performed more quickly by referring to matrix sparsity metadata. These savings in storage space and computing time may be large in machine learning applications, in which sparse matrices are frequently used.

In some embodiments, the methods and processes described herein may be tied to a computing system of one or more computing devices. In particular, such methods and processes may be implemented as a computer-application program or service, an application-programming interface (API), a library, and/or other computer-program product.

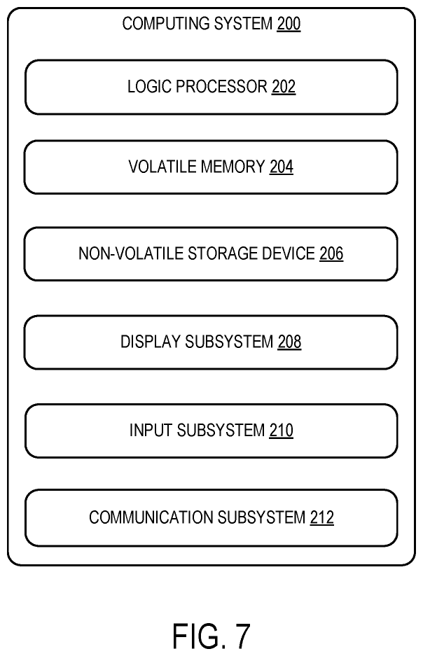

FIG. 7 schematically shows a non-limiting embodiment of a computing system 200 that can enact one or more of the methods and processes described above. Computing system 200 is shown in simplified form. Computing system 200 may embody the computing device 10 described above and illustrated in FIG. 1. Components of the computing system 200 may be instantiated in one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 7.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 200 to send and/or receive messages to and/or from other devices via a network such as the Internet.

The following paragraphs describe several aspects of the present disclosure. According to one aspect of the present disclosure, a computing device is provided, including one or more processing devices configured to receive a first matrix including a plurality of first matrix elements arranged in a plurality of first submatrices. The one or more processing devices may be further configured to generate first matrix sparsity metadata indicating one or more zero submatrices and one or more nonzero submatrices of the plurality of first submatrices. Each of the first matrix elements included in the one or more zero submatrices may be equal to zero. The one or more processing devices may be further configured to store, in memory, a compressed first matrix including the first matrix sparsity metadata and the one or more nonzero submatrices and not including the one or more zero submatrices.

According to this aspect, the one or more processing devices may be further configured to multiply the first matrix and a second matrix to compute a result matrix. Multiplying the first matrix and the second matrix may include computing a plurality of submatrix products of the plurality of first submatrices of the first matrix and a plurality of second submatrices of the second matrix respectively. Computing the plurality of submatrix products may include, for each submatrix product of a zero submatrix of the one or more zero submatrices and a second submatrix of the plurality of second submatrices, setting each submatrix product element of the submatrix product to zero without retrieving, from the memory, the plurality of first matrix elements included in the zero submatrix or the plurality of second matrix elements included in the second submatrix.

According to this aspect, the one or more processing devices may be further configured to assign, to each submatrix product of the plurality of submatrix products, submatrix product sparsity metadata indicating whether the submatrix product is a zero submatrix product for which all the submatrix product elements of the submatrix product are equal to zero.

According to this aspect, multiplying the first matrix and the second matrix may further include computing a submatrix product sum of two or more submatrix products of the plurality of submatrix products that share respective locations in the result matrix. When computing the submatrix product sum, based on the submatrix product sparsity metadata, for each submatrix product of the two or more submatrix products, the one or more processing devices may be configured to determine whether that submatrix product is a zero submatrix product. The one or more processing devices may be further configured to skip adding each zero submatrix product to the submatrix product sum.

According to this aspect, the one or more processing devices may include a hardware accelerator configured to receive the compressed first matrix at a first input buffer, receive the second matrix at a second input buffer, and output the result matrix to a result buffer.

According to this aspect, the one or more processing devices may be further configured to generate a compressed result matrix including result matrix sparsity metadata indicating one or more zero result submatrices and one or more nonzero result submatrices of the result matrix. The compressed result matrix may further include the one or more nonzero result submatrices. The compressed result matrix may not include the one or more zero result submatrices. The one or more processing devices may be further configured to store the compressed result matrix in the memory.

According to this aspect, the first matrix sparsity metadata may indicate each of the one or more zero submatrices with a zero and each of the one or more nonzero submatrices with a one.

According to this aspect, the first matrix sparsity metadata may be stored as a header of the compressed first matrix.

According to this aspect, the plurality of first submatrices may each be of a same size.

According to this aspect, prior to generating the first matrix sparsity metadata, the one or more processing devices may be further configured to determine that one or more first matrix elements of the plurality of first matrix elements are below a predefined threshold. The one or more processing devices may be further configured to set the one or more first matrix elements that are below the predefined threshold to zero.

According to another aspect of the present disclosure, a method for use with a computing device is provided. The method may include receiving a first matrix including a plurality of first matrix elements arranged in a plurality of first submatrices. The method may further include generating first matrix sparsity metadata indicating one or more zero submatrices and one or more nonzero submatrices of the plurality of first submatrices. Each of the first matrix elements included in the one or more zero submatrices may be equal to zero. The method may further include storing, in memory, a compressed first matrix including the first matrix sparsity metadata and the one or more nonzero submatrices and not including the one or more zero submatrices.

According to this aspect, the method may further include multiplying the first matrix and a second matrix to compute a result matrix. Multiplying the first matrix and the second matrix may include computing a plurality of submatrix products of the plurality of first submatrices of the first matrix and a plurality of second submatrices of the second matrix respectively. Computing the plurality of submatrix products may include, for each submatrix product of a zero submatrix of the one or more zero submatrices and a second submatrix of the plurality of second submatrices, setting each submatrix product element of the submatrix product to zero without retrieving, from the memory, the plurality of first matrix elements included in the zero submatrix or the plurality of second matrix elements included in the second submatrix.

According to this aspect, the method may further include assigning, to each submatrix product of the plurality of submatrix products, submatrix product sparsity metadata indicating whether the submatrix product is a zero submatrix product for which all the submatrix product elements of the submatrix product are equal to zero.

According to this aspect, multiplying the first matrix and the second matrix may further include computing a submatrix product sum of two or more submatrix products of the plurality of submatrix products that share respective locations in the result matrix. Based on the submatrix product sparsity metadata, for each submatrix product of the two or more submatrix products, computing the submatrix product sum may include determining whether that submatrix product is a zero submatrix product. Computing the submatrix product sum may further include skipping adding each zero submatrix product to the submatrix product sum.

According to this aspect, the method may further include generating a compressed result matrix including result matrix sparsity metadata indicating one or more zero result submatrices and one or more nonzero result submatrices of the result matrix. The compressed result matrix may further include the one or more nonzero result submatrices. The compressed result matrix may not include the one or more zero result submatrices. The method may further include storing the compressed result matrix in the memory.

According to this aspect, the first matrix sparsity metadata may indicate each of the one or more zero submatrices with a zero and each of the one or more nonzero submatrices with a one.

According to this aspect, the first matrix sparsity metadata may be stored as a header of the compressed first matrix.

According to this aspect, the plurality of first submatrices may each be of a same size.

According to this aspect, the method may further include determining that one or more first matrix elements of the plurality of first matrix elements are below a predefined threshold. The method may further include setting the one or more first matrix elements that are below the predefined threshold to zero.

According to another aspect of the present disclosure, a computing device is provided, including one or more processing devices configured to receive a compressed first matrix including first matrix sparsity metadata and one or more nonzero submatrices. The compressed first matrix may be a compressed form of a first matrix arranged in a plurality of first submatrices and stored in memory. The one or more nonzero submatrices may each include a respective plurality of first matrix elements of the first matrix, with at least one first matrix element included in each of the nonzero submatrices not being equal to zero. The first matrix sparsity metadata may indicate the one or more nonzero submatrices and one or more zero submatrices of the first matrix. Each of the first matrix elements included in the one or more zero submatrices may be equal to zero. The one or more processing devices may be further configured to multiply the compressed first matrix and a second matrix to compute a result matrix. Multiplying the compressed first matrix and the second matrix may include computing a plurality of submatrix products of the plurality of first submatrices of the first matrix and a plurality of second submatrices of the second matrix respectively. Computing the plurality of submatrix products may include, for each submatrix product of a zero submatrix of the one or more zero submatrices and a second submatrix of the plurality of second submatrices, setting each submatrix product element of the submatrix product to zero without retrieving, from the memory, the plurality of first matrix elements included in the zero submatrix or the plurality of second matrix elements included in the second submatrix. The one or more processing devices may be further configured to output the result matrix.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
one or more processing devices configured to:
receive a first matrix including a plurality of first matrix elements arranged in a plurality of first submatrices;
generate first matrix sparsity metadata indicating one or more zero submatrices and one or more nonzero submatrices of the plurality of first submatrices, wherein each of the first matrix elements included in the one or more zero submatrices are equal to zero; and
store, in memory, a compressed first matrix including the first matrix sparsity metadata and the one or more nonzero submatrices and not including the one or more zero submatrices.

2. The computing device of claim 1, wherein:
the one or more processing devices are further configured to multiply the first matrix and a second matrix to compute a result matrix;
multiplying the first matrix and the second matrix includes computing a plurality of submatrix products of the plurality of first submatrices of the first matrix and a plurality of second submatrices of the second matrix respectively; and
computing the plurality of submatrix products includes, for each submatrix product of a zero submatrix of the one or more zero submatrices and a second submatrix of the plurality of second submatrices, setting each submatrix product element of the submatrix product to zero without retrieving, from the memory, the plurality of first matrix elements included in the zero submatrix or the plurality of second matrix elements included in the second submatrix.

3. The computing device of claim 2, wherein the one or more processing devices are further configured to assign, to each submatrix product of the plurality of submatrix products, submatrix product sparsity metadata indicating whether the submatrix product is a zero submatrix product for which all the submatrix product elements of the submatrix product are equal to zero.

4. The computing device of claim 3, wherein:
multiplying the first matrix and the second matrix further includes computing a submatrix product sum of two or more submatrix products of the plurality of submatrix products that share respective locations in the result matrix; and
when computing the submatrix product sum, the one or more processing devices are configured to:
based on the submatrix product sparsity metadata, for each submatrix product of the two or more submatrix products, determine whether that submatrix product is a zero submatrix product; and
skip adding each zero submatrix product to the submatrix product sum.

5. The computing device of claim 2, wherein the one or more processing devices include a hardware accelerator configured to:
receive the compressed first matrix at a first input buffer;
receive the second matrix at a second input buffer; and
output the result matrix to a result buffer.

6. The computing device of claim 2, wherein the one or more processing devices are further configured to:
generate a compressed result matrix including:
result matrix sparsity metadata indicating one or more zero result submatrices and one or more nonzero result submatrices of the result matrix; and
the one or more nonzero result submatrices, wherein the compressed result matrix does not include the one or more zero result submatrices; and
store the compressed result matrix in the memory.

7. The computing device of claim 1, wherein the first matrix sparsity metadata indicates each of the one or more zero submatrices with a zero and each of the one or more nonzero submatrices with a one.

8. The computing device of claim 1, wherein the first matrix sparsity metadata is stored as a header of the compressed first matrix.

9. The computing device of claim 1, wherein the plurality of first submatrices are each of a same size.

10. The computing device of claim 1, wherein, prior to generating the first matrix sparsity metadata, the one or more processing devices are further configured to:
determine that one or more first matrix elements of the plurality of first matrix elements are below a predefined threshold; and
set the one or more first matrix elements that are below the predefined threshold to zero.

11. A method for use with a computing device, the method comprising:
receiving a first matrix including a plurality of first matrix elements arranged in a plurality of first submatrices;
generating first matrix sparsity metadata indicating one or more zero submatrices and one or more nonzero submatrices of the plurality of first submatrices, wherein each of the first matrix elements included in the one or more zero submatrices are equal to zero; and
storing, in memory, a compressed first matrix including the first matrix sparsity metadata and the one or more nonzero submatrices and not including the one or more zero submatrices.

12. The method of claim 11, further comprising multiplying the first matrix and a second matrix to compute a result matrix, wherein:
multiplying the first matrix and the second matrix includes computing a plurality of submatrix products of the plurality of first submatrices of the first matrix and a plurality of second submatrices of the second matrix respectively; and
computing the plurality of submatrix products includes, for each submatrix product of a zero submatrix of the one or more zero submatrices and a second submatrix of the plurality of second submatrices, setting each submatrix product element of the submatrix product to zero without retrieving, from the memory, the plurality of first matrix elements included in the zero submatrix or the plurality of second matrix elements included in the second submatrix.

13. The method of claim 12, further comprising assigning, to each submatrix product of the plurality of submatrix products, submatrix product sparsity metadata indicating whether the submatrix product is a zero submatrix product for which all the submatrix product elements of the submatrix product are equal to zero.

14. The method of claim 13, wherein:
multiplying the first matrix and the second matrix further includes computing a submatrix product sum of two or more submatrix products of the plurality of submatrix products that share respective locations in the result matrix; and
computing the submatrix product sum includes:
based on the submatrix product sparsity metadata, for each submatrix product of the two or more submatrix products, determining whether that submatrix product is a zero submatrix product; and
skipping adding each zero submatrix product to the submatrix product sum.

15. The method of claim 12, further comprising:
generating a compressed result matrix including:
result matrix sparsity metadata indicating one or more zero result submatrices and one or more nonzero result submatrices of the result matrix; and
the one or more nonzero result submatrices, wherein the compressed result matrix does not include the one or more zero result submatrices; and
storing the compressed result matrix in the memory.

16. The method of claim 11, wherein the first matrix sparsity metadata indicates each of the one or more zero submatrices with a zero and each of the one or more nonzero submatrices with a one.

17. The method of claim 11, wherein the first matrix sparsity metadata is stored as a header of the compressed first matrix.

18. The method of claim 11, wherein the plurality of first submatrices are each of a same size.

19. The method of claim 11, further comprising:
determining that one or more first matrix elements of the plurality of first matrix elements are below a predefined threshold; and
setting the one or more first matrix elements that are below the predefined threshold to zero.

20. A computing device comprising:
one or more processing devices configured to:
receive a compressed first matrix including first matrix sparsity metadata and one or more nonzero submatrices, wherein:
the compressed first matrix is a compressed form of a first matrix arranged in a plurality of first submatrices and stored in memory;
the one or more nonzero submatrices each include a respective plurality of first matrix elements of the first matrix, with at least one first matrix element included in each of the nonzero submatrices not being equal to zero; and
the first matrix sparsity metadata indicates the one or more nonzero submatrices and one or more zero submatrices of the first matrix, wherein each of the first matrix elements included in the one or more zero submatrices are equal to zero;
multiply the compressed first matrix and a second matrix to compute a result matrix, wherein:
multiplying the compressed first matrix and the second matrix includes computing a plurality of submatrix products of the plurality of first submatrices of the first matrix and a plurality of second submatrices of the second matrix respectively; and
computing the plurality of submatrix products includes, for each submatrix product of a zero submatrix of the one or more zero submatrices and a second submatrix of the plurality of second submatrices, setting each submatrix product element of the submatrix product to zero without retrieving, from the memory, the plurality of first matrix elements included in the zero submatrix or the plurality of second matrix elements included in the second submatrix; and
output the result matrix.
